(19) United States
(12) Patent Application Publication
(10) Pub. No.: US 2009/0172077 A1
(43) Pub. Date: Jul. 2, 2009

(54) Apparatus for and a Method of Delivering a Message to a User

(76) Inventors: David Roxburgh, Woodbridge (GB); Matthew W. Capp, Ipswich (GB); Simon A. Beddus, Ipswich (GB); Michael R. Hosking, Ipswich (GB)

Correspondence Address: NIXON & VANDERHYE, PC, 901 NORTH GLEBE ROAD, 11TH FLOOR, ARLINGTON, VA, 22203, US

(21) Appl. No.: 12/085,200

(22) PCT Filed: Nov. 23, 2006
(86) PCT No.: PCT/GB2006/004375

§ 371 Date: May 19, 2008

(30) Foreign Application Priority Data
Nov. 23, 2005 (EP) 05257213.8
Mar. 7, 2006 (EP) 06251198.5

(51) Int. Cl. G06F 15/16

(52) U.S. Cl. 709/202

(57) ABSTRACT

Apparatus for delivering a message to a user comprising means for communicating with service providers and means for communicating with device agents operating on respective user devices, wherein the service provider communicating means is configured to receive a request to communicate with a specified user and to selectively output a message for the user to said device agent communicating means and wherein the device agent communicating means is configured to maintain a list of connected device agents, to receive said message and to transmit said message to a selected device agent dependent upon a routing policy for said user.

The present invention relates to apparatus for and a method of delivering a message to a user.

A growing number of services can now be delivered to an increasing variety of user devices via a rising number of different networks. This proliferation of services, devices and networks can present the user with problems, such as the need to manage an ever-growing number of accounts, devices and device configurations. Furthermore, services, devices and networks are likely to become more specialized which can lead to inconsistencies in the ways services are accessed and devices are operated. It can also introduce inflexibility in the manner in which services are delivered. Additionally, service providers face problems when delivering services to users since users may only be sporadically available. Moreover, users can be difficult to identify and authenticate and can also be unpredictable, unreliable and inconsistent. These problems tend to hinder successful and seamless provision of services.

For example, online auction operators recognise the opportunity to increase revenue when a bidder is outbid. eBay's auction system detects outbid incidents and raises events which are consumed by various auxiliary systems and can be routed to qualified external applications built and operated by third parties. This decoupling of event detection and event consumption produces a powerful yet flexible mechanism which maximises the opportunity to dynamically build upon the capabilities and value of the auction engine—the auction engine can be extended and integrated into new systems very easily without the need for downtime and regression testing. However, once any of the auction or third party workflow processes require interaction with the user (e.g. to ask if they would like to increase their bid), things take a turn very much for the worse . . . the lack of any reliable method for defining and conducting a structured interaction with the user leaves the system designer with very few options. Typically, the designer might opt to simply fire off an email and hope for the best. In the best case, the user will be ‘on email’ and so receive the email before the auction ends; the user is then required to launch a browser, log in, review the auction and proceed through the web site process required to place a higher bid. With the dominance of email threatened by the rise in viruses, phishing and general spam and increasing adoption of alternatives such as SMS and IM, the efficacy of relying on individual channels such as email is in decline. Besides the fragility and security weaknesses of the mechanism, in reality, given the prevalence of ‘sniping’ in online auctions, the window of opportunity typically exists only for a matter of minutes and so the chance of avoiding the revenue loss by this method is correspondingly slim. This method of extending the workflow process to involve the user is clearly vulnerable to many failure modes and might generously be described as ‘best effort’.

The issues illustrated above face service providers (SPS) across all sectors offering many different services and if reaching users within the domain of one network technology is problematic then true convergence¹ presents a whole new order of complexity since there are so many more channels to address. ¹ By ‘true convergence’ we mean the convergence of the telco and Online Service Provider worlds (rather than Fixed-Mobile Convergence—the convergence of fixed and mobile telecoms).

In terms of cost-benefit analysis, the use of email remains attractive even where it returns limited benefit since it comes at almost no cost.

Alternatively, bespoke solutions can deliver great benefits. As well as sending out emails, eBay is experimenting with a bespoke approach in a strategic agreement with Volantis. eBay and Volantis have co-designed a GPRS/3G/SMS solution which extends the eBay experience out to mobile devices. Every device model is treated as a different device—users are informed of events by SMS which include links which will launch their device's browser to connect to a page, specifically constructed for that service feature/user/device combination, which allows the user to deal with the event.

In general, bespoke solutions fall into the high-cost, high-benefit quadrant—made-to-measure solutions with a made-to-measure price tag. The costs of a convergent bespoke solution can be pushed still higher by the myriad of networks and devices which need to be catered for and the rapid rate of growth/change in those devices. Although the supplier might make efforts to mitigate it, the inherent cost structure of bespoke solutions is also an issue for all but the biggest, most firmly established SPs as all the cost of the development is incurred up-front—pay-per-use cost models are often preferred since they spread the risk. And then there is the cost to the user where they are required to install multiple bespoke components—one per SP—on each of their devices.

Of course, the cost-benefit quadrant which SPs want to buy into is the high-benefit, low-cost region, and, typically, that means exploiting shared, common, re-useable infrastructure. Web Services are one such infrastructure—this technology is extremely successful in providing a mechanism whereby contracts can be defined which establish a firm foundation for machine-to-machine communications. The technical benefits translate into cost savings and new business opportunities. If an equivalent mechanism were available to define and Implement contracts for machine-to-user two-way structured dialogues then this too would dramatically increase the power and intimacy of SPs communications with their customers, leading to new solutions, improved customer satisfaction and new consumer propositions.

Various technology developments are underway to address aspects of this problem and some of them are reviewed later in this paper.

In this specification, we describe how our prototype system illustrates a concept—the concept that SPs might be offered a simple mechanism to access a shared infrastructure for the conduct of more powerful and intimate communications with their customers regardless of device and network. We call this ‘User Integration’ since it allows the SP to integrate their customers much more closely into their business and processes. It is relatively straight-forward to show how the concept of User Integration addresses the existing demand for improvement in SP-to-consumer communications using a few illustrative examples. It is harder to show what new opportunities it might create—just as the manner and volume of SMS usage was unforeseen, as service and solution designers accept that users have become highly available for integration into processes, they could be expected to exploit the new ‘user component’ in ways which aren't immediately obvious.

According to a first aspect of the present invention there is provided apparatus for delivering a message to a user, the apparatus comprising means for communicating with service providers and means for communicating with device agents operating on respective user devices, wherein the service provider communicating means is configured to receive a request to communicate with a specified user and to selectively output a message for the user to the device agent communicating means and wherein the device agent communicating means is configured to maintain a list of connected device agents, to receive said message and to transmit the message to a selected device agent dependent upon a routing policy for the user.

Thus, the apparatus can provide a point of access to the user for service providers. The apparatus can handle communications between the service provider and the user in a consistent way.

The message may include service data, such as content or a link to content, or service-related data, such as an alert or information about a service. The message may be in XML format.

The device agent communicating means may comprise means for co-operating with a device agent to establish a connection. The device agent communicating means may comprise at least two means for co-operating with respective device agents via respective types of user device connectivity. This can help the apparatus to reach the user since one type of connectivity may be available if another type of connectivity is not.

The apparatus may be configured to prepare the message having a structured format and including a device-readable instruction specifying a data format of data to be input into the device by the user. The message may be in a mark-up language and the device-readable instruction may comprise mark-up tags for identifying an instruction and an element and/or attribute for identifying a data format. The device-readable instruction may comprise a user-selectable response for providing, for example, so called “pull down” options.

According to a second aspect of the present invention there is provided user apparatus comprising means for communicating with a message delivery apparatus, the communicating means configured to maintain a connection with the message delivery apparatus and to receive a message from the message delivery apparatus.

The user apparatus may be configured to receive user input to render the message and, in response to said user input, to transmit an acknowledgement to the message delivery apparatus. This can be used to confirm receipt of the message to the sender of the message. The user apparatus may be configured to prompt the user to provide input data according to a data format specified in the message and to prepare a reply including said input data and to transmit a response to the message delivery apparatus. This can help to standardise the response returned to the sender. The user apparatus may be configured to store an operation included in said message, said operation being selectable by the user such that, when said operation is selected by the user, the apparatus is configured to present another message to the user and to prompt the user to provide input data according to the content of the other message. This can help to standardise a spontaneous message sent to a service provider.

According to a third aspect of the present invention there is provided a system comprising a message delivery apparatus, at least one user apparatus and at least one service provider, the at least one service provider configured to transmit a request to the message delivery apparatus, the user apparatus configured to determine whether to send a message to the user, to deliver said message to a selected one of the at least user apparatus, to receive a response from the user apparatus and to deliver said response to the service provider.

The service provider may be configured to prepare the request having a structured format, such as in a mark-up language, and to include, in the message, a device-readable instruction specifying a data format of data to be input into the device by the user. This can help the service provider to collect data from a user.

Thus, the system can facilitate communication between the user and a service provider.

According to a fourth aspect of the present invention there is provided a server comprising processing means and Interfacing means, the processing means configured to prepare a message for a user, the message having a structured format and including a device-readable instruction specifying a data format of data to be input into a device by a user and the interfacing means configured to transmit the message to a predetermined message delivery apparatus.

The processing means may be configured to prepare the message in a mark-up language. The processing means may be configured to include mark-up tags for identifying an instruction and an attribute for identifying a data format. The processing means may be configured to include a user-selectable response.

The interfacing means may be configured to receive a reply from the message delivery apparatus, the reply including data in the data format, and reading the data.

According to a fifth aspect of the present invention there is provided a method of delivering a message to a user, the method comprising maintaining a list of connected device agents, receiving a request to communicate with a specified user, selectively outputting, in response to receiving the request, a message for the user, receiving said message and transmitting said message to a selected device agent dependent upon a routing policy for said user.

The method may further comprise preparing the message having a structured format and including, in the message, a device-readable instruction specifying a data format of data to be input into the device by a user.

According to a sixth aspect of the present invention there is a method of messaging, the method comprising preparing the message having a structured format for a user, including, in the message, a device-readable instruction specifying a data format of data to be input into the device by the user and transmitting the message to a predetermined router.

Preparing the message having a structured format may comprise preparing the message in a mark-up language. Including in the message the device-readable instruction may comprise including mark-up tags for identifying an instruction and an attribute for identifying a data format. Including the device-readable instruction comprises may include a user-selectable response. The method may further comprise selecting one of a plurality of devices associated with the user and transmitting the message to the one device. The method may comprise receiving a reply from the message delivery apparatus, the reply including data in the data format and reading the data.

According to a seventh aspect of the present invention there is a computer program, which when executed by data processing apparatus, causes the apparatus to perform the method.

According to a eighth aspect of the present invention there is a computer readable medium storing the computer program.

Embodiments of the present invention will now be described, by way of example only, with reference to the accompanying drawings in which:

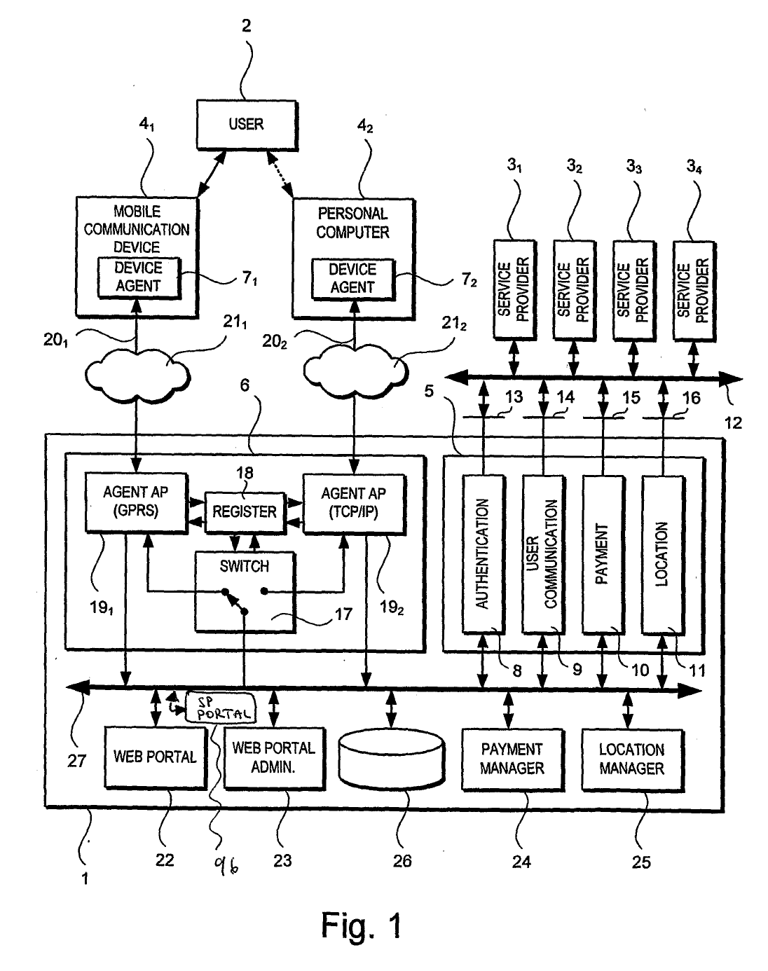

FIG. 1 is a schematic block diagram of apparatus for delivering a message to a user from any one of plurality of service providers via any one of a plurality of user devices and vice versa in accordance with the present invention;

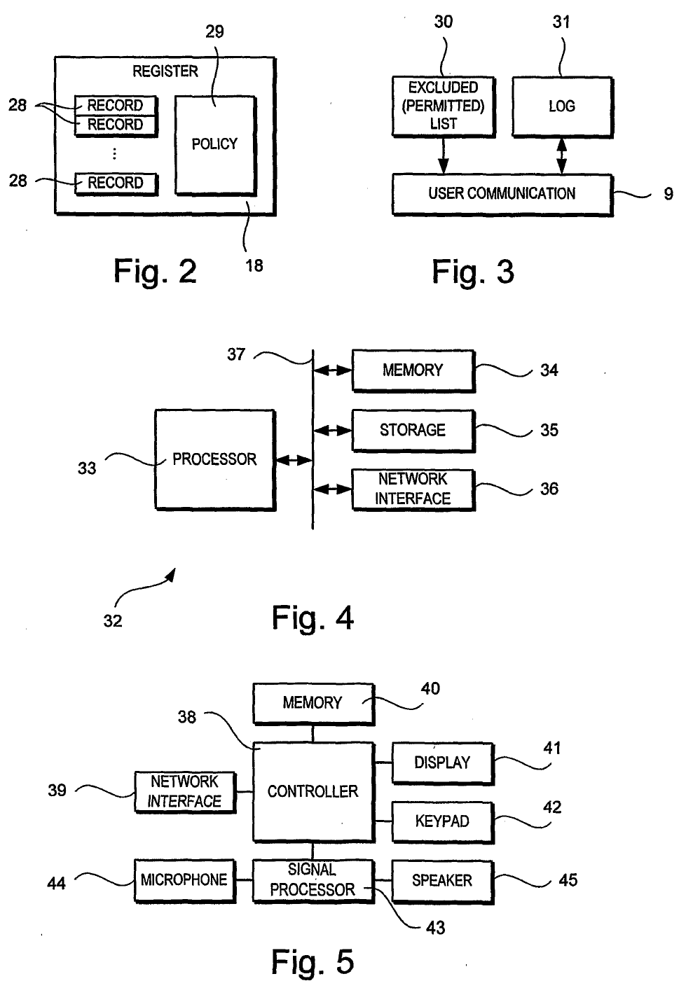

FIG. 2 is a schematic block diagram of a register;

FIG. 3 is a schematic block diagram of a module for handling requests to communicate with a user, together with excluded list and log databases;

FIG. 4 is a schematic block diagram of the apparatus shown in FIG. 1;

FIG. 5 is a schematic block diagram of a user device shown in FIG. 1;

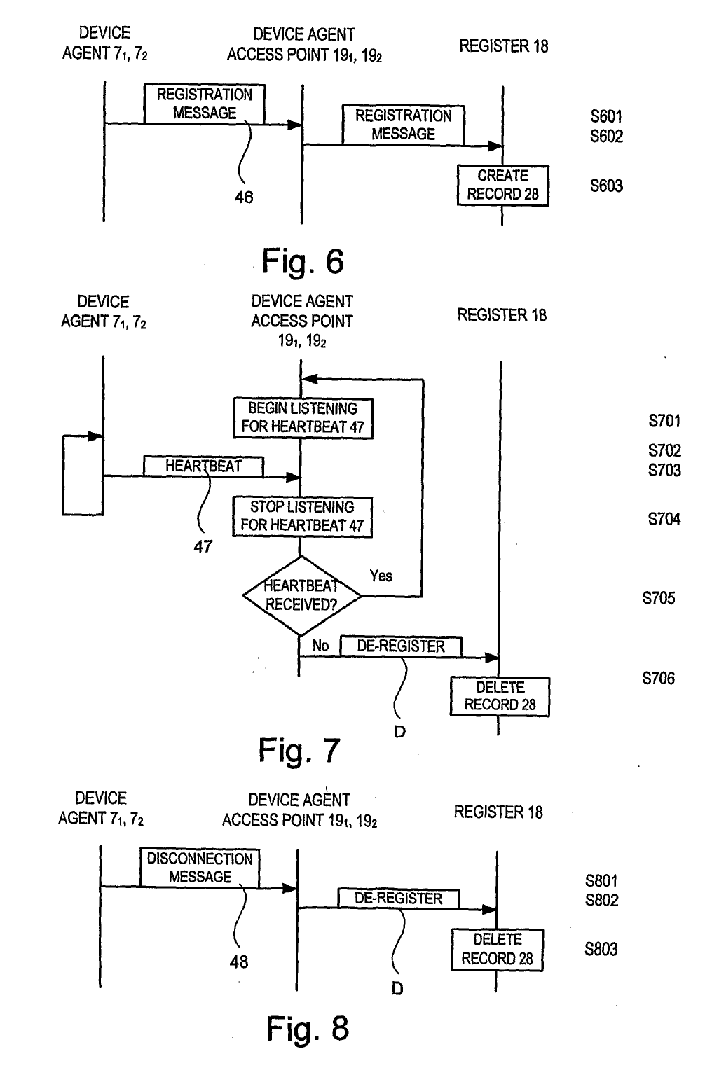

FIG. 6 is a process flow diagram of a method of connecting to a service agency;

FIG. 7 is a process flow diagram of a method of maintaining a connection with a service agency;

FIG. 8 is a process flow diagram of a method of disconnecting from a service agency;

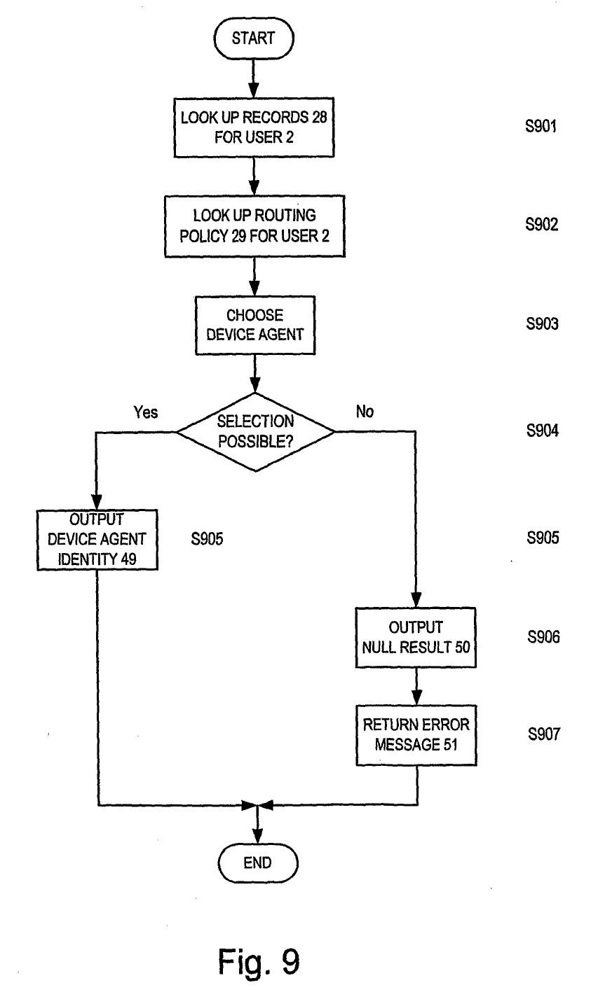

FIG. 9 is a process flow diagram of a method of determining which device agent to use;

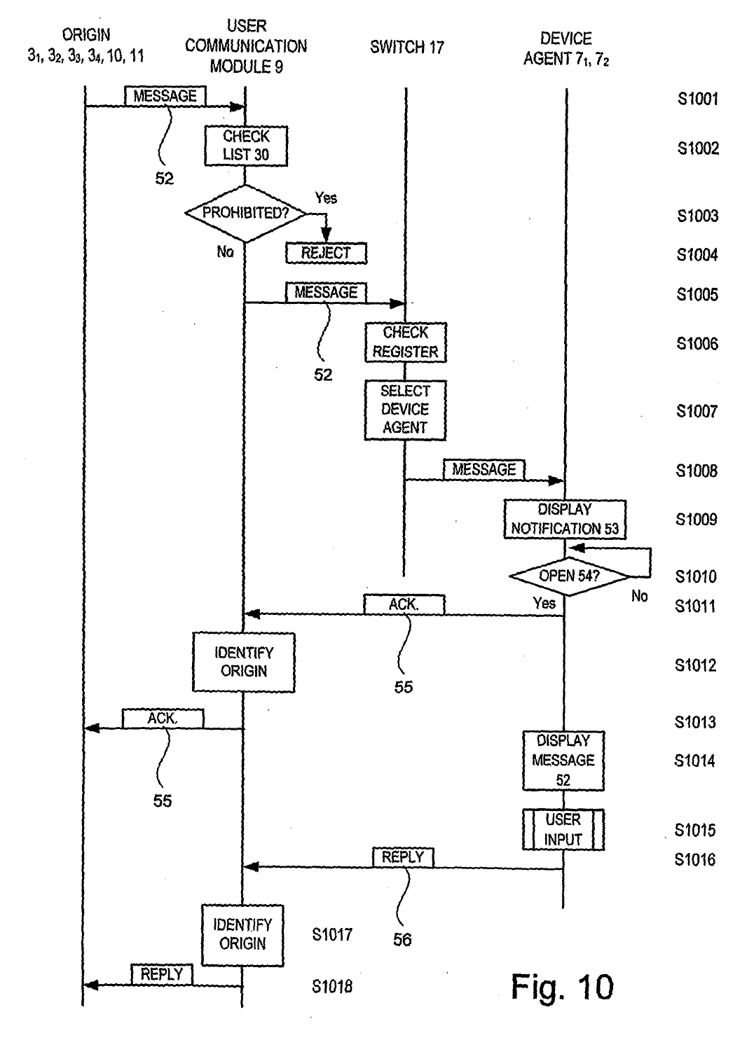

FIG. 10 is a process flow diagram of a method of delivering a message to a user in accordance with the present invention;

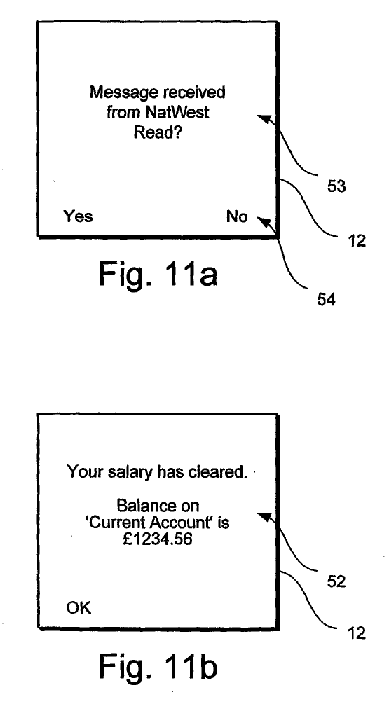

FIGS. 11a and 11b illustrate, respectively, notification of receipt of a first example of message and display of the message sent using the process shown in FIG. 10;

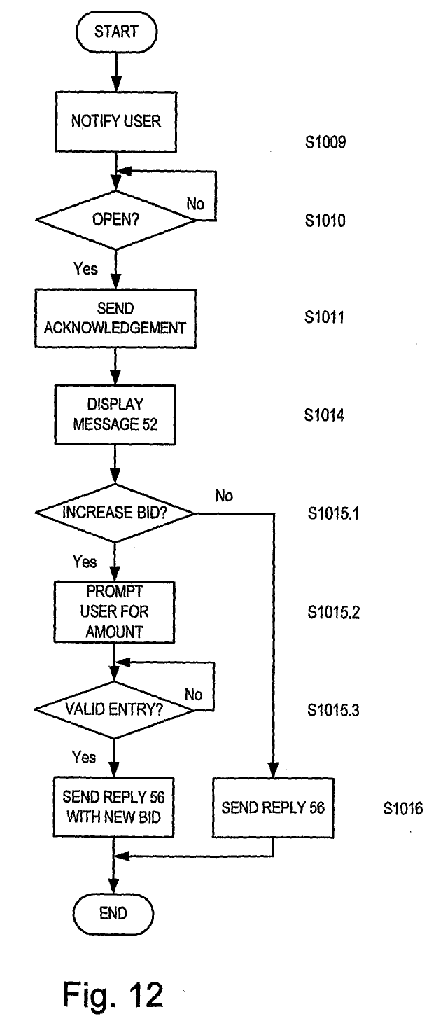

FIG. 12 is a process flow diagram of a method of receiving and displaying a message and sending a response;

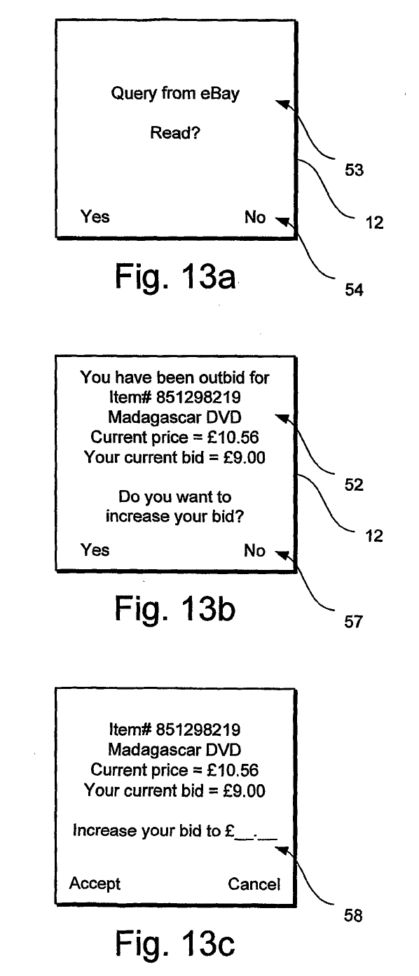

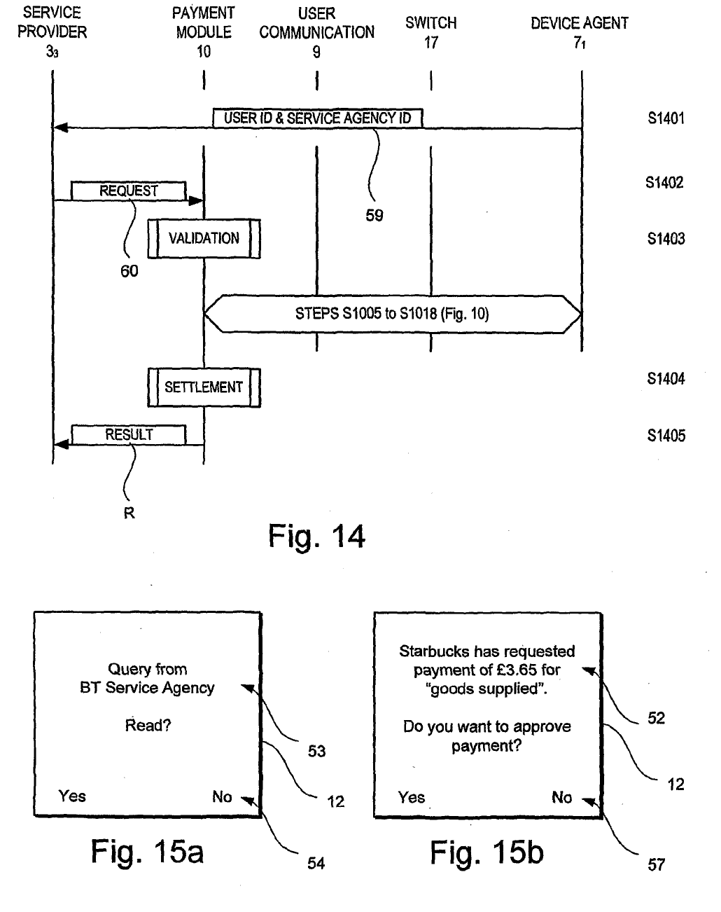

FIGS. 13a, 13b and 13c illustrate, respectively, notification of receipt of a second example of message, display of the message and preparation of a response using the process shown in FIG. 10 and employing the process shown in FIG. 12;

FIG. 14 is a process flow diagram of a method of sending a payment authorisation request message to a user and receiving a payment authorisation message in accordance with the present invention;

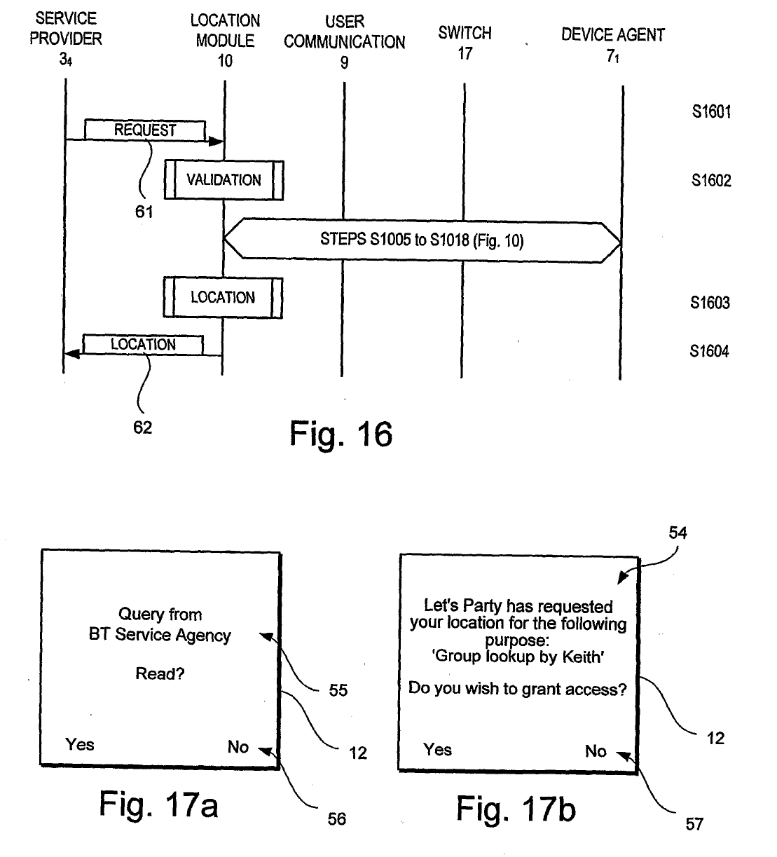

FIGS. 15a and 15b illustrate, respectively, notification of receipt of the payment authorisation request message and display of the message sent using the process shown in FIG. 14;

FIG. 16 is a process flow diagram of a method of sending a lookup request message to a user and receiving a lookup authorisation message in accordance with the present invention;

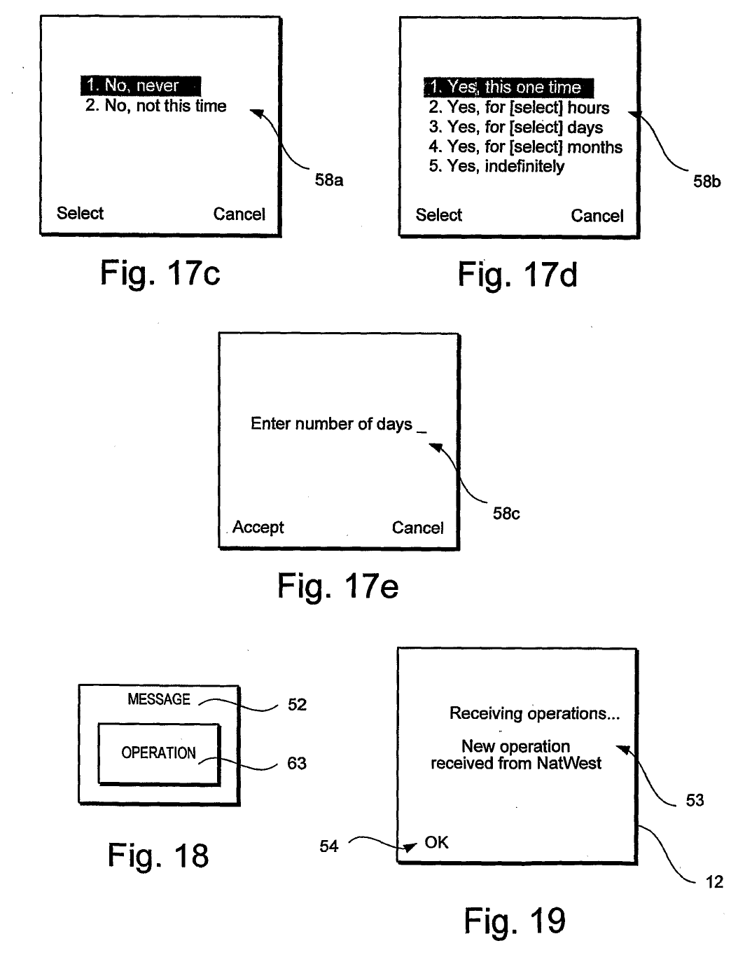

FIGS. 17a to 17e illustrate notification of receipt of the lookup authorisation request message, display of the message and preparation of the authorisation response using the process shown in FIG. 16;

FIG. 18 is a schematic diagram showing a message carrying an operation;

FIG. 19 illustrates notification of receipt of a message carrying an operation;

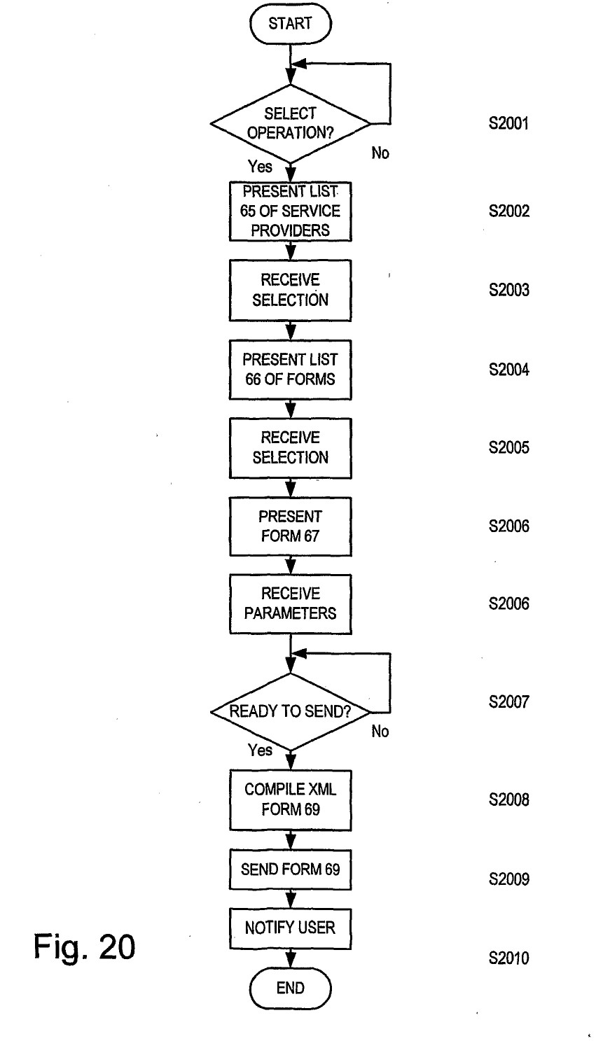

FIG. 20 is a process flow diagram of a method of processing a message carrying an operation; and

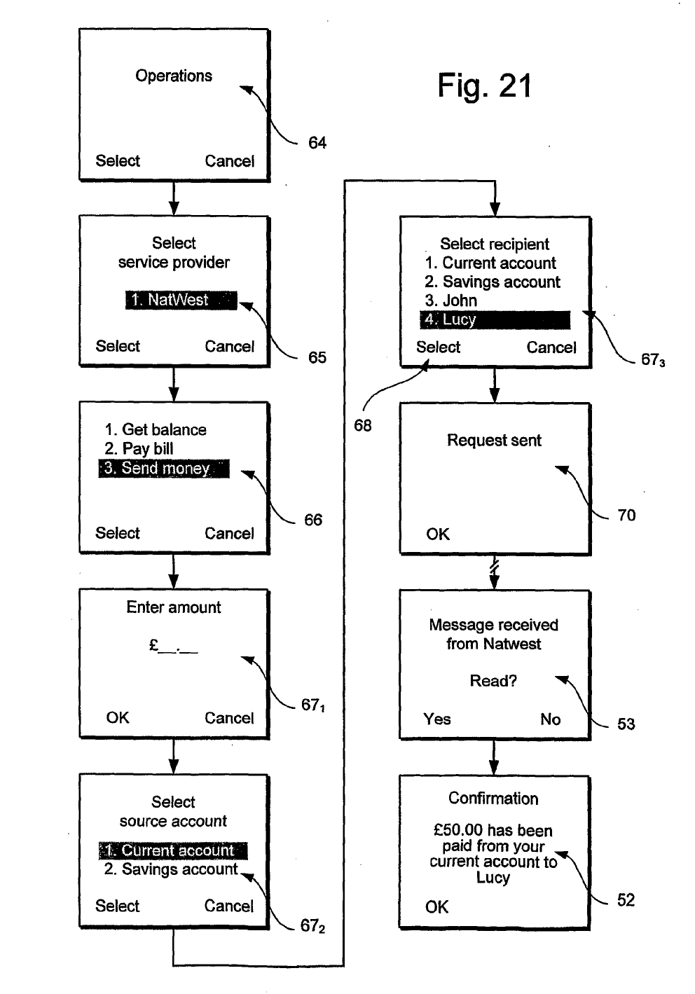

FIG. 21 illustrates selection and use of an operation.

A prototype system is structured as shown in FIG. 1. Each device 4 runs a ‘Device Agent’ 7 which manages a connection with the Device Access Point 6 and a user interface. The initial devices supported are the Windows XP™ desktop, a Nokia™ 6680 J2ME™/Symbian™ device and a Windows Mobile™ v5.0 PDA.

The Service Support System (SSS) 1 mediates between SPs 3 and consumers 2 in order to operate the User Integration capability. User Integration augments conventional service provision—consumers continue to access the SP's existing systems directly via browser, voice or other channel in addition to using the User Integration channel.

The API Exposure Engine 5 allows SPs 3 to connect to the SSS 1 over a set of secure, managed APIs. The Device Access subsystem 6 supports the connections out to the consumers' devices 4 (Device Agents 7). The design incorporates the notion of consumer 22, SP 96 and admin 23 portals for the management and reporting of each party's interests. Consumers would use the consumer portal 22 to manage their preferences and devices, view transaction histories, reset passwords, etc. SPs would use the SP portal 96 to manage their API usage, access reporting functions and view billing data, etc. The SSS administrators would use the admin portal 23 to manage consumers, SPs and the SSS platform 1.

User Integration allows SPs to reach consumers in two distinct modes:
Extemporal ‘User Query’—SP Defined, SP Initiated Instigated by the SP, typically in response to an event detected by the SP. For example, “You have been outbid, do you want to increase your bid?”. The Query will typically offer the user several valid responses.
Pre-Provisioned ‘Command’—SP Defined, Consumer Initiated Pre-provisioned to the user (the user's devices) in advance such that the user can execute commands at any time in the future. For example, “Pay a bill.”

Both Queries and Commands are defined by the SP 3 and submitted to User Integration by calls on an API. Both incorporate ‘Forms’ which are completed by the consumer and transmitted back to the SP 3—Commands incorporate one Form per Command (e.g. “Pay x to y”) while Queries incorporate one Form per valid response (“No” and “Yes, to z pounds”)². ² Where x, y and z are Name Value Pair parameters which are defined by the SP and have their values set by the consumer.

The main methods of the User Integration API which were deployed in a first embodiment took the form shown in Table 1.

TABLE 1
User Integration API methods

| Method | Usage |
|---|---|
| sendQuery(userID, | The SP calls this method to request that a |
| queryDefinition) | query be sent to the specified user. |
| provisionCommand(userID, | The SP calls this method to request that a |
| commandDefinition) | command be provisioned to a user. |

Communications from consumers to SPs take the form shown in Table 2.

TABLE 2
User Integration Notifications to SPs

| Notification | Usage |
|---|---|
| Ack(queryID) | Indicates to the SP that the user has |
| | viewed the Query. |
| QueryResponse(queryID, | Delivers the user's Query Response to the |
| responseID, | SP. |
| formParameters) | |
| CommandExecution(userID, | Delivers a user's Command Execution |
| commandID, | Request to the SP. |
| formParameters) | |

Importantly, since the SP 3 defines the entire message, including the Forms to be returned to it, there is no requirement for domain-specific intelligence outside of the SP's systems. Thus, the mechanism can be re-used by any number of applications and services, returning high-value domain-specific behaviour on a low cost common infrastructure. User Integration can be exposed via a simple interface using for example Web Services, CORBA, XML, RMI, RPC or other technology favoured by the target market (the SPs). As suggested in FIG. 1, User Integration will generally not sit alone—many more such capabilities will be offered alongside it (as discussed further below). Let us assume that there is significant benefit from offering these capabilities in a common way with common management and billing functions. In any case, the capability must be secure and managed such that usage can be controlled and billed. Conveniently such a common exposure facility can be thought of as an API Exposure Engine 5 and several solutions exist including the applicant's proposed 21CN Capability Exposure Framework.

The nature of the User Integration capability, where messages from the consumer to the SP 3 are sent both solicited and unsolicited, leads to an additional requirement—for a mechanism whereby the API Exposure Engine 5 can initiate communications with the SP's system in order to Inform it of such events. Again, let us assume that there is significant benefit from having this function performed in a common way across all capabilities rather than reinventing it in slightly different ways for each capability. Various solutions exist including a Notification Server which is the subject of applicant's international patent application WO2005/096590 (internal reference A30441).

We use the prototype system to run through a storyboard which demonstrates User Integration in operation. The demonstration assumes that the consumer has one or more User Integration-compatible devices active at all points in time throughout and that their bank has pre-provisioned a number of Commands to the user. The common user experience across devices means that consumers can use any device to conduct of any of the sequences within the storyboard to the same effect.
1. SP uses Query to inform user
   The consumer's bank sends a message (a Query with zero valid responses) to inform the consumer that suspicious activity has been detected on one of their accounts and that account has been locked down for security. The bank benefits from knowing that one simple API call will return a high probability that the message will be received and an acknowledgement when it is. The consumer receives the message regardless of device and network and since the chain is mediated by a trusted Service Support System operator (e.g. BT), they can be sure that the message is genuine.
2. SP uses Query to interact with user
   The consumer's online auction provider sends a Query informing them that they have been outbid and asking if they would like to increase their bid. The consumer can select ‘no’ or ‘yes’ and indicate their new bid. The auction provider's systems can easily interpret and act upon the user's response.
3. User uses Command to request service
   The consumer browses their pre-provisioned Commands and finds one provisioned to them by their bank called “Pay a Bill”. The consumer selects this Command and completes the Form to request that the bank pay £123.45 to the consumer's credit card provider. The bank may subsequently send a message by User Integration to indicate the completion/failure of the transaction.

For SPs, one of the benefits of the design is that reuse of a common infrastructure delivers low costs but the way in which it is exposed allows them to interact with the consumers using structure, terminology and semantics which suit their customers, service domain and systems/processes.

Important aspects of the design which contribute to the delivery of this favourable cost/benefit profile are:

the data model—which uses the SP ID to provide each SP with a namespace in which to manage their own message indexing, referencing, terminology and thereby, interaction semantics; and
the Form element—allows the SP to define the parameterised Query Responses and Command Execution Requests which constrain the user to returning only syntactically and semantically valid responses.

### Device Support

The Device Access to Device Agent communications follow a common functional template but the structure of the Device Access subsystem allows those functions to carried on the wire in very different ways to cater for different network and device types and configurations. This flexibility is achieved by a plug-in structure which allows new communication requirements to be catered for by plugging in a new ‘drivers’ (or plug-ins) as required. The main functional specification that all plug-ins must conform to is the interface between the plug-in and the Device Access subsystem.

In this embodiment we have simply wrapped all communications in an asynchronous XML protocol carried over TCP/IP sockets. The design is intended to make it straightforward to carry the XML over HTTP or move to SIP/SIMPLE if/where required.

The Register holds records of each user's connections into the platform from zero or more devices, regardless of the network(s) used for transport. The requirements on the connection between the Device Agent and the platform can vary according to the device, network and network operator's practices (e.g. NAT, firewall rules). The Device Access sub-system has an architecture which allows new plug-ins to be deployed to support these different on-the-wire requirements and to circumvent any hostile network operator practices. All plug-ins present the same interface to the platform. To communicate with a user, the Register/Selector decides which of a user's devices to use and directs the communication to the correct plug-in for that device. Each Device Agent might support many connection types and switch between them automatically as necessary.

Empirically, 3^{rd} Party Service Providers are able to use this embodiment to define communications with their customers with structure, terminology and semantics natural to their own customer base/service domain. They can then use the common infrastructure exposed via API such that their automated systems can conduct the required interactions with their consumers in real time on a range of devices over a range of networks with very similar user experiences on each and without the SP needing to know anything about the user's device or network. From the third party Service Provider's perspective, the solution is simple to use and the end-to-end solution requires zero touch on the client-side. As one would expect of a shared, re-useable infrastructure, the User Integration capability cost structure is related to use rather than a up-front development phase.

As an alternative to the Device Agent approach, IVR could be used to conduct the interactions with users over any voice channel. This channel would present a number of advantages:
The opportunity to use voice recognition to enhance security.
Support for ‘legacy’ devices.
Hands-free operation.

From experience in developing and deploying Device Agents to different devices on the Windows XP™ desktop, Nokia™ 6680 J2ME™/Symbian™ and Windows Mobile™ v5.0 platforms it would appear that these platforms are sufficiently powerful to allow for a similar look-and-feel to the Device Agent to be achieved across devices.

The technology approach taken in building the prototype embodiment was one which supported the experimental nature of the work. Technologies appropriate for the development of a product version of such a facility are discussed later in this specification.

Clearly, the prototype embodiment which has been built does not present any one network as the key element in users' online lives, indeed quite the contrary is true. While the networks retain some key functions such as authenticating terminals and reliable transport, the non-network-related value (user identity, man-to-machine interaction, payment control, location data control) is lifted up out of the networks into the Service Support System. This provides the opportunity for all networks to be exploited for the convergence of the user experience.

We have defined our Query and Command Forms in a pseudo-HTML language. It might be argued that existing standard such as HTML or XForms should be adopted. While these technologies clearly offer support for the definition of ‘forms’ in the general sense, options for integrating them into the User Integration Query and Command data structures within the surrounding framework, the exposure mechanism (API) and trust model are not so clear. The current version of HTML does not achieve the required separation between the purpose and presentation of the form, which is why we used a modified version and why the XForms initiative has been formed. Adoption of XForms may be advantageous if it gains support from the toolset vendors since SPs could then employ the same form definitions via User Integration and other channels.

SIP would appear to be an ideal solution to the presence question—a global solution, providing every consumer with their own address, readily useable by any SP across any network. However, where network operators deploy SIP they will typically do so for commercial gain. 3GPP has standardized the SIP addressing scheme to be employed by 3G operators; SIP addresses will be tied to terminals, not users and it is not clear what arrangements will be in place to alias SIP addresses, allow third-party device capability registration and expose access outside the operator's systems. While SIP seems to be a natural solution to the multi-network presence question, for commercial reasons network operators may feel it necessary to limit third parties exploitation of their SIP infrastructure where they see such use by third parties directly competing with their own ability to add value to the user service experience. As such, further consideration of SIP and how best to exploit it is likely to be needed as SIP deployment plans and aspirations for 3G (and other new networks) mature.

Clearly, the interface used in this embodiment would benefit from augmentation with further control and monitoring functions such as prioritisation, store-and-forward support, time-to-live specification, delivery state query and message recall as per protocols like SMPP for SMS.

The reader will have noticed the similarities between the machine-to-human interaction solution presented in this paper and the human-to-human solutions offered by the likes of MSN Messenger, BT Communicator and Agile Messenger. These platforms provide a natural jumping-off point from which a User Integration offering could be launched.

This application describes ways in which a common service element which we have called ‘User Integration’ could be offered as a service via API to 3^{rd} Party Service Providers, offering them a mechanism to enhance their relationship with their customers in a converged world with minimal complexity, on a common shared infrastructure which should minimise costs and present a very attractive risk profile, particularly to smaller SPS.

User Integration is an example of what we have termed Key Common Service Elements—elements of service provision which do not in themselves form the value of the service offering but which are nonetheless essential to the optimisation of the overall service experience and are becoming increasingly complex as true convergence happens.

If it is possible to combine User Integration with a portfolio of other Key Common Service Elements in a way in which 3^{rd} Party Service Providers can easily use and consumers find convenient; and if this is offered on the right commercial terms by an operator who the 3^{rd} Party Service Providers and consumers know and trust then the long-term opportunity is for operators in that role to support all users access to all electronic services. One can consider the operator of this service support role a ‘Service Agency’ and we are investigating ways in which other Key Common Service Elements can be offered alongside User Integration.

The “storyboard” set out above illustrates the User Integration capability in operation. The storyboard can be extended as shown below to illustrate some of the wider Service Agency ideas in operation.
System re-uses User Integration in support of a converged payment capability
The consumer orders a coffee at a retail outlet. The demonstration shows how the User Integration mechanism in combination with other developments exploiting the trust model underlying the Service Support System can be used to allow the consumer to authorise the transfer of those funds from their online payment system to the retailer.
System re-uses User Integration in support of a converged location capability
A request is received for the consumer's location data. In a similar way that the User Integration mechanism can be used to give the consumer control over payment, it can give the consumer control over their location data privacy. Furthermore, careful design of Interactions allows user profiling to be ‘grown’ with minimal effort on the consumer's behalf. For example, when asking if a consumer's location data should be released to a SP, allowing responses such as “Yes, allow access for x days.” enables subsequent requests to be served without troubling the consumer.

Note: The above shows User Integration being employed, not by SPs, but other Key Common Service Elements (Payment and Location). Thus, the Service Agency can employ User Integration as a common channel to offer the user a way to manage various facets of their online activities in a consistent way across services and providers.

We have presented a vision of a new facility enabling SPs to form closer, more effective relationships with their customers across networks and devices and simplifying the service experience for consumers. Such a facility, providing key elements of users' online experience such as authentication, payment and privacy, would occupy a powerful position in the electronic service supply value-chain. In the longer term, further opportunities to influence user behaviour may develop such as promoting particular networks for the transport of communications traffic.

The Invention will now be further described in greater detail, with reference to the accompanying figures.

Referring to FIG. 1, apparatus 1 for delivering a message to a user 2 from any of plurality of service providers 3₁, 3₂, 3₃, 3₄ via any of a plurality of user devices 4₁, 4₂ in accordance with the present invention is shown. The apparatus 1 provides a point of access for the service providers 3₁, 3₂, 3₃, 3₄ to deliver and receive messages to and from the user 2 and is hereinafter referred to as a “service agency”. For clarity, only one user 2 is shown in FIG. 1 and in this specification the system is described with reference to only one user 1. However, the service agency 1 can deliver messages to any of a plurality of users.

The service agency 1 includes a gateway 5 for communicating with service providers 3₁, 3₂, 3₃, 3₄ and a module 6 for communicating with device agents 7₁, 7₂ operating on respective user devices 4₁, 4₂.

The service provider gateway 5 includes a module 8 for receiving and handling requests to authenticate the user 2, a module 9 for receiving and handling requests to communicate with the user 2, a module 10 for receiving and handling requests for settling payment made by the user 2 and a module 11 for receiving and handling requests to locate the user 2. The user communication module 9 can receive requests from service providers 3₁, 3₂, 3₃, 3₄ and from the other modules 8, 10, 11.

The service providers 3₁, 3₂, 3₃, 3₄ are connectable to the modules 8, 9, 10, 11 by a network 12, such as the Internet, via respective application programming interfaces 13, 14, 15, 16. The service providers 3₁, 3₂, 3₃, 3₄ each include a server (not shown) which includes, among other things, processing means (not shown) and interfacing means (not shown).

The device agent communicating module 6 includes a switch 17 for routing outgoing communication data to a selected device agent 7₁, 7₂, a register 18 and device agent access points 19₁, 19₂. Two device agent access points 19₁, 19₂ are illustrated. However, additional access points (not shown) may be provided to support further network types or transport requirements.

The switch 17 may be configured to refer to the register 18 to identify which device agent 7₁, 7₂ to use for each user 2 at any given moment.

Alternatively the arrangement can be such that multiple, typically all, device agents of any user be addressed with a message for that user.

The device agent access points 19₁, 19₂ co-operate with the device agents 7₁, 7₂ to establish connections 20₁, 20₂ via networks 21₁, 21₂. The device agent access points 19₁, 19₂ authenticate the device agents 7₁, 7₂. Authentication based on user name and password or PIN or stronger forms of authentication based on V.509 certificates or biometrics, such as fingerprint or iris scans, may be used. The device agents 7₁, 7₂ identify the user and their availability and can also identify the type of device on which it operates and the capabilities of device, such as bandwidth, memory availability, processing power and forms of output.

The device agent access points 19₁, 19₂ are provided for each type of user device connectivity, in this example general packet radio service (GPRS) network and an IP network. Device agent access points for different or additional types of network connectivity may be provided, such as for universal mobile telephone system (UMTS) network, wireless local area network based on IEEE 802.11x standards, such as so-called “WiFi”, wireless metropolitan area network based on IEEE 802.16 standards, sometimes referred to as “WiMax” and other wireless and wired device connectivity. The access points 19₁, 19₂ need not necessarily form part of network infrastructure and/or provide a network interface for a given type of connectivity. Instead, the access points 19₁, 19₂ may be connected via a network (not shown), such as the Internet, to the appropriate network infrastructure (not shown), such as a GPRS network, or to a remote network interface (not shown), such as a wireless LAN access point or network adapter, cable modem.

Messages for the user may be transmitted in the form of eXtensible Mark-up Language (XML) documents. The documents can be validated using a Document Type Definition (DTD) file, such as:

| <!ELEMENT event (response*)> | |
|---|---|
| <!ATTLIST event | |
| eventID | CDATA #REQUIRED |
| serviceProviderName CDATA #REQUIRED | |
| serviceName | CDATA #REQUIRED |
| message | CDATA #REQUIRED |
| > | |
| <!ELEMENT response (#PCDATA)> | |
| <!ATTLIST response | |
| value | CDATA #REQUIRED |
| > | |

Messages can thus specify that a service (serviceName), run by a service provider 3₁, 3₂, 3₃, 3₄ (serviceProviderName), wishes to convey a message (message) to the user 2. If the appropriate fields in the XML document are present, then the user may respond with any one of the given valid responses (response). Extensions can be made to specify valid additions to the allowed responses.

Where events are generated by a service provider 3₁, 3₂, 3₃, 3₄, the serviceProviderName and serviceName fields can be set accordingly. Where events are generated by the service agency 1, the same fields can be used accordingly.

Attachments, such as style-sheets and graphics, can be used to provide a more attractive presentation, for example, which is rich in content.

As will be described in more detail later, the message may be in the form of a text message. However, the message may include content, such as a jpeg file, or a link to content, such as a universal resource locator (URL).

Other structured message formats can be used instead of XML, such as hypertext markup language (HTML) and XForms.

Referring still to FIG. 1, the service agency 1 also includes a web portal 22, a web portal administrator module 23, a payment manager 24, a location manager 25 and a database 26 connected via a connection layer 27.

The web portal 22 allows a user 2 to log in to the service agency 1 and configure settings, such as granting permission to the service agency 1 to handle certain functions, such as payment, view activity, such as payment activity, and set privacy and security policies.

Referring to FIG. 2, the register 18 holds records 28 of all connected device agents 7₁, 7₂ for the user 2. Each record 28 includes the identity of the user 2, the identity of a device agent access point 19₁, 19₂ and information about user availability. The register 18 also holds a policy 29 for determining which device agent 7₁, 7₂ should be used.

Referring to FIG. 3, the user communication module 9 is provided with a list 30 of excluded and/or permitted service providers and/or message types and a log 31 of incoming and outgoing messages. The excluded (permitted) list 30 and log 31 may be stored in database 26 (FIG. 1).

Referring to FIG. 4, the service agency 1 is run on a server 32 or other computer. The server 32 has a processor 33, memory 34, storage 35 and at least one network interface 36, connected by a system bus 37. The server 32 may include other elements, such as caches (not shown), and peripherals, such as displays and keyboards (not shown), but these are omitted for clarity. The service agency 1 may be implemented as a distributed system, such as a cluster of servers.

Referring again to FIG., 1 first and second user devices 4₁, 4₂ are a mobile communications device 4₁, in the form of a second-generation mobile telephone handset, and a personal computer (PC) 4₂ respectively. Different or additional user devices (not shown) may be used, such as a third-generation mobile telephone handset, a personal data assistant, a smart phone, a set-top box or other computing device capable of being connected to a network. Furthermore, more than one user device of the same type may be provided. For example, the user may have access to more than one PC. The mobile communications device 4₁ is provided with GPRS connectivity to a mobile telephone network and the personal computer 4₂ is provided with wired connectivity to the Internet.

User devices of the same type may have different network connectivity. Even if user devices have the same network connectivity, then the network connectivity or the network may have different operating capabilities, such as different bandwidth, and/or different pricing structure. Furthermore, any network (or network segment) may be provided by different network providers. Thus, even though the user can be reached by at least two user devices of similar capability, it may be preferable to contact the user via a specific user device.

Referring to FIG. 5, the mobile communications device 4₁ is shown in more detail.

The device 4₁ includes a controller 38, a network interface 39, memory 40, a display 41, keypad 42, a signal processor 43, a microphone 44 and a speaker 45.

It will be appreciated that user devices 4₁, 4₂ need not be mobile and can have a different configuration.

The device agents 7₁, 7₂ (FIG. 1) can be pre-loaded on a user device 4₁, 4₂. Alternatively, the user may download the device agent 7₁, 7₂ as-and-when required. This can be convenient if the user accesses a user device to which they would not normally have access, such as a PC in an Internet café.

### Operation

Referring again to FIG. 1, the service agency 1 and device agents 7₁, 7₂ cooperate to allow the user 2 to be incorporated more efficiently and effectively as part of a service delivery system. The service agency 1 and device agents 7₁, 7₂ can improve delivery of service to the user by providing a set of re-useable user-oriented service functions.

The service agency 1 can provide non-real-time functions, while the device agents 7₁, 7₂ can provide the real-time functions and real-time user interaction support. The device agents 7₁, 7₂ may be present in different forms on each user device 4₁, 4₂ and the service agency 1 determines which device agent 7₁, 7₂ instances are available and preferable for performing different functions.

For example, if the user 2 is carrying a mobile communications device 4₁ and accessing a powerful desktop personal computer 4₂, then the service agency 1 can take advantage of the capability, performance and usability of the personal computer 4₂ and route services or other service-related communication to the device agent 7₂ running on the personal computer 4₂. However, if the user 2 logs off the personal computer 4₂, then the service agency 1 can employ the device agent 7₁ on the mobile communications device 4₁ and route services or service-related communication to the device agent 7₁. Even if the mobile communications device 4₁ cannot support a desired operation, the user 2 can still be notified of events and execution options, such as delivery of content, for example a copy of “Monsters Inc.” to the user's home media centre (not shown).

Thus, the user can be integrated into the system more effectively and the service agency 1 can help to optimise service delivery and provide service-related messaging over any network and device.

When the user device 4₁, 4₂ is connected to a corresponding network 21₁, 21₂, each device agent 7₁, 7₂ registers with the service agency 1. Preferably, the service agency 1 authenticates the device agent 7₁, 7₂.

Referring to FIG. 6, each device agent 7₁, 7₂ sends a registration message 46 to the service agency 1 (step S601). For example, the registration message 46 may include XML data in the following form:

<?xml version=\“1.0\”?>
<register>
<version>J2SEv1.0</version>
<userID>sa:mary.delaney@bt.com</userID>
</register>

The registration message 46 is sent to an access point 19₁, 19₂ according to device connectivity. The access point 19₁, 19₂ may be specified by the device agent 7₁, 7₂, for example using an IP address or telephone number. Alternatively, the network 21₁, 21₂ may route the registration message to a specific access point 19₁, 19₂.

Once the registration message 46 has been received by an access point 19₁, 19₂, it is forwarded to the register 18 (step S602). The register 18 creates a record 28 including the user identity (userID) and the access point 19₁, 19₂ and may include data describing the device agent 7₁, 7₂, connection session and device capabilities (step S603). The register 18 may also search for other entries for the same user and may update the routing policy 29 (FIG. 2).

Referring to FIG. 7, each device agent 7₁, 7₂ connected to the service agency 1 sends a confirmation message 47 to the service agency 1 to maintain the connection. The confirmation message 47 is hereinafter referred to as a “heartbeat” and can take the following form:
<?xml version=\“1.0\”?><heartbeat/>

The access point 19₁, 19₂ begins listening for heartbeats 47 (step S701). The device agent 7₁, 7₂, sends a heartbeat 47, preferably periodically, for example at an interval between 1 and 100 seconds (step S702). The access point 19₁, 19₂ determines whether the heartbeat 47 has been received within a given time window (steps S704 & S705). If the heartbeat 47 (or a predefined number of consecutive messages) is (are) not received as expected, then the access point 19₁, 19₂ sends an instruction D to the register 18 to deregister the device agent 7₁, 7₂ (step S705). The register 18 then removes the record 28 (step S706). A disconnection message (not shown) may be transmitted to the network 21₁, 21₂ for delivery to the device agent 7₁, 7₂. If the heartbeat 47 is received, then the access point 19₁, 19₂ continues listening (step S701).

Referring to FIG. 8, each connected device agent 7₁, 7₂ can notify the service agency 1 that it wishes to disconnect itself from the service agency 1. The device agent 7₁, 7₂ sends a disconnection message 48 to the service agency 1 (step S801). For example, the disconnection message 48 may include XML data in the following form:
<?xml version=\“1.0\”><bye/>

The access point 19₁, 19₂ receives the disconnection message 49 and sends an instruction D to the to the register 18 to deregister the device agent 7₁, 7₂ (step S802). The register 18 removes the record 28 (step S803).

As explained earlier, the resister 18 maintains a list of records 28 of which device agents 7₁, 7₂ are connected. The register 18 also stores a routing policy 29 (FIG. 2) for determining which device agent 7₁, 7₂ to use.

Referring to FIG. 9, the register 18 may be called upon to provide information to the switch 17 (FIG. 1) for routing a service or service-related communication to the user 2. The register 18 looks for records 28 related to the user 2 (step S901) and looks up the routing policy 29 (FIG. 2) (step 902). Dependent on which device agent 7₁, 7₂ are connected and the routing policy 29 (FIG. 2), the register 18 chooses a device agent 7₁, 7₂ (step S903). If a suitable device agent 7₁, 7₂ is available, then the register 18 outputs the identity 49 of a device agent 7₁, 7₂ and/or an access point 19₁, 19₂ (step S904). If no device agents 7₁, 7₂ are connected or if device agents 7₁, 7₂ are connected but do not conform with the routing policy 29 (FIG. 2), then the register 18 outputs a null result 50 (step S906). Optionally, an error message 51 may be returned for replying to the sender, for example to the service provider 3₁, 3₂, 3₃, 3₄.

The policy 29 may include instructions as to how to deal with a message which cannot be delivered. For example, the register 18 may keep a record (not shown) of previous messages and responses or information, such as statistics, regarding previous messages and responses. The register 18 can deduce a rule from previous messages and responses. Additionally or alternatively, the user may set defaults which include forwarding rules. Thus, if a message is received which cannot be delivered, then the register 18 may respond on behalf of the user 2 based on predefined rules.

As explained earlier, the service agency 1 can be used to forward service or service-related data to the user 2. For example, a bank may send a message to the user 2.to notify the user 2 that their salary has cleared. An on-line auction house may send a message to the user 2 to notify them that they have been outbid and to ask whether they wish to raise their bid. The service agency 1 itself can send a message to the user 2 to notify them that the service agency has received a request to settle a payment or to release information about the location of the user. These examples will now be described in more detail.

Referring to FIG. 10, a first service provider 3₁, which in this case is a bank, transmits a message 52 to the service agency 1, requesting communication with the user 2 to notify the user 2 that their salary has cleared (step S1001). The message 52 can be in any predetermined format and specifies the identity of the user 2, a message and, optionally, valid response definitions. Preferably, web services are used to send the message and the message is in XML format, in a form ready to be forwarded to a device agent 7₁. However, other protocols can be used, such as Java Remote Method Invocation (RMI), and the message need not be in XML. If the message is not in XML, then the message is reformat, for example, by extracting data from pre-specified fields and placing the data into fields in an XML document.

The user communication module 9 checks the list 31 (FIG. 3) to determine whether the service provider 3₁ or the message 52 is prohibited or allowed (step S1002). If the service provider 3₁ or the message 52 is prohibited, then the message 52 is rejected (step S1003). A rejection message (not shown) may be returned.

If necessary, the message 52 can be translated or reformatted and the message 52 is forwarded to switch 17 (step S1004). The message 52 is time stamped and the service provider can be identified. For example, the message 52 can take the following form:

<?xml version=\“1.0\”?>
<interaction>
<reference>1234567</reference>
<originator>NatWest</originator>
<message> Your salary has cleared. Balance on ‘Current Account’ is
£1234.56</message>
</interaction>

The message 52 is received by the switch 17, which checks the register 18 (step S1005) and receives the identity of the access point 19₁, 19₂ to which the message 52 should be forwarded (step S1006). The message 52 is forwarded, via the appropriate access point 19₁, to the device agent 7₁ (step S1007) on one of the devices 4₁, 4₂. In this example, the device 4₁ is the mobile communications device.

Referring also to FIG. 11a, a notification message 53 is presented by the device agent 7₁ on the display 12 of the user device 4₁ for notifying the user 2 of receipt of the message 52 (step S1008). The notification message 53 offers options 54 for reading the message 52, such as “Yes” and “No”, which can be selected using soft keys (not shown) of keypad 42 (FIG. 5).

The notification message 53 can take different forms depending upon the type of user device. For example, if the user device is a PC, then the notification message can take the form of an icon in a notification area (sometimes referred to as a “system tray”) or a pop-up dialogue box.

If the user enters an instruction to display the message 52, for example by pressing the “Yes” soft-key of the keypad 43 (FIG. 5) (step S1010), then the device agent 7₁ sends an acknowledgement message 55 to the service agency 1, which is transmitted via the access point 19₁ to the communications module 9 (step S1011). For example, the acknowledgement message 55 can take the form:

<?xml version=\“1.0\”?>
<interactionAck>
<reference>1234567</reference>
</interactionAck>

The user communication module 9 can look up the reference number in log 31 (FIG. 3) and identify the origin, in this case the service provider (step S1012). The user communication module 9 can then forward the acknowledgement to the service provider 3₁ (step S1013).

Referring also to FIG. 11b, if the user enters an instruction to display the message 52 at step S1010, then the device agent 7₁ presents the message 54 to the user (step S1014).

In the example just described, the device agent 7₁ returns an acknowledgement message 55. However, the device agent 7₁ need not do so. Notwithstanding this, the method may include further steps to allow the user to send a reply 56 to a message, as will now be described in more detail.

A second service provider 3₂, which in this case is an on-line auction service provider, transmits a message 52 to the service agency 1, in this example, requesting to notify the user 2 that their bid has been outbid and inviting them to raise their bid.

Steps S1001 to S1014 are carried out substantially as described earlier. However, the message 52 is modified and can take the following form:

<?xml version=\“1.0\”?>
<interaction>
<reference>57465875</reference>
<originator>eBay</originator>
<message>You have been outbid [Item#4503830952, ‘Monsters, Inc.
(DVD 2002)’, current price GBP 3.2]. Do you want to increase your
bid?</message>
<response id=”1”>No</response>
<response id=”2”>Yes - to GBP {da:intext name=’Amount’} (min
3.4)</response>
</interaction>

Referring to FIGS. 12 and 13a, a notification message 53 is presented by the device agent 7₁ on the display 12 of the user device 4₁, as described earlier (step S1009). The notification message 53 offers options 54 for reading the message 52.

If the user enters an instruction to display the message 52 (step S1010), then the device agent 7₁ sends an acknowledgement message 55 (step S1011). In this case, the acknowledgement message 55 can take the form:

<?xml version=\“1.0\”?>
<interactionAck>
<reference>57465875</reference>
</interactionAck>

Referring also to FIG. 13b, if the user enters an instruction to display the message 54 at step S1009, then the device agent 7₁ presents the message 52 to the user (step S1014). Unlike the previous example of the message 52, the message 52 offers options 57 for user input, in other words, for responding to the message 52.

In this example, the device agent 7₁ offers the user 2 the options “Yes” and “No” to the question “Do you want to increase your bid?”.

Referring to FIG. 13c, if the user selects the option “Yes”, i.e. to increase the bid, then a prompt 58 is presented to the user to enter a new bid (steps S1015.1 & S1015.1). The device agent 7₁ may validate the amount entered (steps S1015.3).

The device agent 7₁ sends a reply 56 to the service agency 1, which is transmitted via the access point 19₁ to the user communication module 9 (step S1016). For example, the reply message 56 can take the form:

<?xml version=\“1.0\”?>
<interactionResponse>
<reference>57465875</reference>
<response>2</response>
<parameter name=“Amount”>12.00</parameter>
</interactionResponse>

Referring again to FIG. 10, the user communication module 9 can look up in the log 31 (FIG. 3), the reference number and identify the service provider (step S1017). The user communication module 9 can then forward reply 56 to the service provide 3₂ (step S1018).

The use of a predefined message format, such as XML, and structure including an identifier or markup, in this case the <response> tag, and elements (or element modifier) and attributes, in this case intext and name respectively, allows the service agency 1 and/or service providers 3₁, 3₂, 3₃, 3₄ to define what parameters should be collected from the user and/or the format of the data.

Other structures using other elements such as {da:inenum}, {da:pound} and {da:lt} can be used. The structure {da:inenum} can be used to make a selection from a list. The structure {da:pound} specifies the need to show a pound (“£”) sign. The structure {da:lt} specifies the need to show “<” sign.

In the examples previously described, the content of the message originates from a service provider 3₁, 3₂ and the device agent sends an acknowledgement 55 and/or reply 56 which is returned to a service provider 3₁, 3₂. However, the service agency 1 may generate messages and process acknowledgements or replies, as will now be described in more detail.

Referring to FIG. 14, the user 2 visits a third service provider 3₃, such as a coffee shop or other service or retail outlet. The user 2 can pay for goods by giving their user ID and service agency ID to the service provider 3₃ (step S1401). For example, this could be done at point of sale by wirelessly transmitting the user ID and service agency ID as a message 59 via an infrared link, such as IrDA™, or a radio frequency link, such as Bluetooth™. Other methods of transmission can be used. The service provider 3₃ transmits a request 60 for settlement to the payment module 10 (step S1402). The payment module 10 may validate the service provider 3₃ (step S1403).

Steps S1001 to S1016 (FIG. 10) are carried out substantially as described earlier. However, the content of the message 52 differs and can take the following form:

<?xml version=\“1.0\”?>
<interaction>
<reference>7654321</reference>
<originator>Service Agency</originator>
<message>Starbucks has requested payment of £3.65 for
“goods supplied”. Do you want to approve payment?</message>
<response id=”1”>No</response>
<response id=”2”>Yes</response>
</interaction>

Referring also to FIG. 15a, a notification message 53 is presented by the device agent 7₁ on the display 12 of the user device 4₁, as described earlier. The notification message 53 offers options 54 for reading the message 52. However, the acknowledgement message 55 is returned to the payment module 9 and is not sent to the service provider 3₃.

Referring also to FIG. 15b, in this example, the message 52 notifies the user 2 that the service provider 3₃ has requested settlement of payment and offers options 55 for the user input for authorising or prohibiting payment.

The device agent 7₁ sends a reply message 56 to the service agency 1, which is transmitted via the access point 19ᵢ to the user communication module 9, as described earlier. For example, the reply message 56 can take the form:

<?xml version=\“1.0\”?>
<interactionResponse>
<reference>7654321</reference>
<response>1</response>
</interactionResponse>

Referring also again to FIG. 10, the user communication module 9 looks up the reference number and identify the origin, which in this case is the payment module 10 and forwards the reply message 59 to the service provide 3₂.

If the payment is authorised, then the payment module 10 settles the payment with the service provider 3₃ (step S1404). A result R, confirming payment (or non-payment) may be returned to the service provider 3₃ (step S1405).

A fourth service provider 3₄ may request information about the user, such as the location of the user. The user can authorise the release of information in a way similar to that described in the previous example.

Referring to FIG. 16, the service provider 3₄ sends a request 61 to the location module 11 for the location of the user 2 (step S1601). The location module 11 may validate the payment module 10 (step S1602).

Steps S1001 to S1016 (FIG. 10) are carried out substantially as described earlier.

Referring to FIGS. 17a and 17b, the device agent 7₁ notifies the user 2 with a notification message 53 and displays the message 52, together with options 57 for authorising or prohibiting release of information.

Referring to FIGS. 17c to 17e, the device agent 7₁ prompts the user 2 to specify a time limit for authorising or prohibiting the release of information via a plurality of prompts 58a, 58b, 58c. The device agent 7₁ sends a reply message 56 to the service agency 1, which is transmitted via the access point 19₁ to the location module 11.

If the release of information is authorised, then the location module 11 determines or retrieves the location of the user 2 (step S1603) and forwards the information to the service provider 3₄ (step S1603).

In the examples previously described, service provider 3₁, 3₂, 3₃, 3₄ or the service agency 1 initiates communication with the user. The service provider 3₁, 3₂, 3₃, 3₄ or the service agency 1 sends a message 52 to the user and the device agent 7₁, 7₂ returns an acknowledgement 55 or reply 56.

However, the service provider 3₁, 3₂, 3₃, 3₄ or the service agency 1 can send a message 52 with data for allowing the device agent 7₁, 7₂ to initiate future communication, as will now be described.

Referring to FIG. 18, a service provider 3₁, 3₂, 3₃, 3₄ can send a device agent 7₁, 7₂ a message 52 which includes at least one operation 63 which is executable by the device agent 7₁, 7₂. The user can initiate execution of operations at a later time.

The service provider 3₁, 3₂, 3₃, 3₄ transmits a message 52 to the user substantially as hereinbefore described in steps S1001 to S1013 (FIG. 10). The message 52 may take the following form:

<?xml version=\“1.0\”?>
<operation>
<originator>NatWest</originator>
<origRef>23887</origRef>
<displayName>Send money</displayName>
<description>Send money to one of your pre-configured
accounts.</description>
<form>Send {da:intext name=’Amount’} from {da:intext name=’Source
Account’ value=’Current Account|Savings Account’} to {da:intext
name=’Recipient’ value=’Current Account|Savings
Account|John|Lucy’}.</form>
</operation>

The message 52 includes fields ({da:}) which define the form of parameters to be collected from the user 2. This provides a facility for service provides 3₁, 3₂, 3₃, 3₄ to provide the user 2 with ability to send a message spontaneously to the service provider 3₁, 3₂, 3₃, 3₄ containing data in a pre-defined format. Thus, the service provider 3₁, 3₂, 3₃, 3₄ can process the message.

The use of a pre-defined message format and a predefined identifier or markup, in this case the <form> tag, allows the service agency 1 and/or service providers 3₁, 3₂, 3₃, 3₄ to define what parameters should be collected from the user.

Referring to FIG. 19 and taking the example of the mobile communication device 4₁, the device agent 7₁ notifies the user of receipt of the message 52 containing at least one operation 63. The device agent 7₁ acknowledges receipt, as described earlier. The device agent 7₁ stores the operation 63 in memory 40 (FIG. 4).

Referring to FIGS. 20 and 21, the user 2 navigates a menu and selects an operations option 64 (step S2001).

The device client 7₁ presents the user 2 with a list 65 of service providers for which operations are available (step S2002). The user 2 selects a service provider (step S2003) and the device client 7₁ presents the user 2 with a list 66 of forms (step S2004). The user 2 selects a form (step S2005) and the device client 7₁ presents the user 2 with the form 67 (step S2004). In this example, the device client 7₁ presents the form 67 in several parts 67₁, 67₂, 67₃.

The user inputs parameters into the form (step S2006) and selects an option 68 to send the form (step S2007). The device client 7₁ compiles the form (step S2008) and sends the compiled form 69 as a message to the service agency 1 (S2009). The compiled form 69 may take the following form:

<?xml version=\“1.0\”?>
<operationRequest>
<originator>NatWest</originator>
<origRef>23887</origRef>
<parameter name=“Amount”>50.00</parameter>
<parameter name=“Source Account”>Savings Account</parameter>
<parameter name=“Recipient”>Lucy</parameter>
</operationRequest>

The device client 7₁ may display a notification message 70 confirming that the message has been sent (step S2010).

The compiled form 69 is handled in substantially the same way as the reply 56 (FIG. 10). The form 69 is received by the service provider or the agency 1 and may send a message 54 using steps S1001 to S1014 described earlier.

It will be appreciated that many modifications may be made to the embodiments hereinbefore described. For example, the messages need is not be XML. The device agent can be configured to render messages in other forms, such as synthesised speech. The device agent can be configured to receive user input in other ways, for example via a touch screen or voice command.

1. Service agency apparatus for delivering a message to a user from any of plurality of service providers via any of a plurality of user devices, the apparatus providing a point of access for the service providers to deliver and receive messages to and from the user, the apparatus including a gateway for communicating with the service providers and an agent communication module for communicating with device agents operating on respective user devices, the gateway including a user authentication module for receiving and handling requests to authenticate the user, a user communication module for receiving and handling requests to communicate with the user, a payment module for receiving and handling requests for settling payment made by the user and a location module for receiving and handling requests to locate the user, wherein the user communication module can receive requests from service providers and from the other modules, and wherein the service providers are connectable to the modules by a network via respective application programming interfaces.

2. Service agency apparatus as claimed in claim 1, comprising processing means and interfacing means, wherein the processing means is configured to prepare a message for a user, the message having a structured format and including a device-readable instruction specifying a data format of data to be input into a device by a user and the interfacing means configured to transmit the message to a predetermined message delivery apparatus.

3. Service agency apparatus as claimed in claim 2, wherein the interfacing means is configured to receive a reply from the message delivery apparatus, the reply including data in the data format, and to read said data in the data format.

4. Service agency apparatus as claimed in claim 1, wherein the gateway for communicating with the service providers is configured to receive a request to communicate with a specified user and to selectively output a message for the user to device agent communicating means and wherein the device agent communicating means is configured to maintain a list of connected device agents, to receive said message and to transmit said message to a selected device agent dependent upon a routing policy for said user.

5. Apparatus according to claim 4, wherein the message comprises the request.

6. Apparatus according to claim 4, wherein the message includes service data or service-related data.

7. Apparatus according to claim 4, wherein the message includes at least one field which defines a form of parameter to be entered by the user.

8. Apparatus according to claim 4, wherein the gateway is configured to extract data from said request and to prepare said message using said data.

9. Apparatus according to claim 4, wherein said gateway is configured to check a list of conditions for allowing and/or refusing requests and to output said message according to said conditions.

10. Apparatus according to claim 4, wherein the gateway is configured to generate the request to communicate with the specified user.

11. Apparatus according to claim 4, wherein the agent communication module comprises means for cooperating with a device agent to establish a connection.

12. Apparatus according to claim 4, configured to prepare or check that the message has a structured format and includes a device-readable instruction specifying a data format of data to be input into the device by the user.

13. Apparatus according to claim 12, wherein the device-readable instruction comprises mark-up tags for identifying an instruction and an element and/or attribute for identifying a data format.

14. Apparatus according to claim 12, wherein the device-readable instruction includes a user-selectable response.

15. A system comprising: a message delivery apparatus to deliver a message to a user, the apparatus comprising: means for communicating with service providers; and means for communicating with device agents operating on respective user devices, wherein the service provider communicating means is configured to receive a request to communicate with a specified user and to selectively output a message for the user to said device agent communicating means and wherein the device agent communicating means is configured to maintain a list of connected device agents, to receive said message and to transmit said message to one or more selected device agent dependent upon a routing policy for said user; at least one user apparatus for receiving a message, the apparatus comprising means for communicating with a message delivery apparatus, the communicating means being configured to maintain a connection with the message delivery apparatus and to receive a message from the message delivery apparatus; and at least one service provider, said at least one service provider being configured to transmit a request to the message delivery apparatus, the user apparatus being configured to determine whether to send a message to the user, to deliver said message to a selected one of the at least user apparatus, to receive a response from the user apparatus and to deliver said response to the service provider.

16. A system according to claim 15, wherein the service provider is configured to prepare the request having a structured format and to include a device-readable instruction specifying a data format of data to be input into the device by the user.
